(19) United States
(12) Patent Application Publication
(10) Pub. No.: US 2007/0109576 A1
(43) Pub. Date: May 17, 2007

(54) Printer controller, printer control method and storage medium

(75) Inventor: Hideki Fujimoto, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/389,141

(22) Filed: Mar. 27, 2006

(30) Foreign Application Priority Data
Nov. 15, 2005 (JP) 2005-330124

(51) Int. Cl. G06F 3/12

(52) U.S. Cl. 358/1.13

(57) ABSTRACT

A printer controller includes a driver module which controls operation of a control subject printer to be controlled, and an application module. The driver module includes: a conversion table referencing section which refers to a conversion table that correlates, for a prescribed printer control item, a control parameter suitable for the control subject printer and a control parameter suitable for a conversion subject printer that is different from the control subject printer; a control parameter acquiring section which acquires the control parameter that is output from the application module, is corresponding to the printer control item, and is suitable for the conversion subject printer; and a control parameter converting section which converts the acquired control parameter into the control parameter suitable for the control subject printer according to the conversion table, and outputs the resulting control parameter.

### BACKGROUND

1. Technical Field

The present invention relates to a printer controller, a printer control method, and a program for controlling operation of a control subject printer on the basis of an instruction from an application module such as a business application.

2. Related Art

In general, when a document used by an application program is printed, a printer driver program which is installed separately from the application program is called. As a result, it is not necessary to describe, in the application program, such information as specifications and control instructions specific to a particular printer, whereby a prescribed printing result is obtained irrespective of the printer type.

However, a business application program is usually provided as part of a system including a particular printer. Therefore, it is difficult to replace the particular printer (dedicated printer) with a different type of a printer (replacement printer) For example, a memory space having a size specific to a printer driver of the dedicated printer is reserved, or data having a structure specific to the printer driver of the dedicated printer is used.

Where such an application program that does not conform to general development rules is installed, replacement of a dedicated printer with a different type of d printer (replacement printer) due to a failure or the like of the dedicated printer may cause trouble that an application program does not operate or the printer does not produce an intended output. This is because, for example, the printer drivers of the dedicated printer and the replacement printer have differences in part of the data structure or require memory spaces of different sizes.

### SUMMARY

The present invention has been made in view of the above circumstances and provides a printer controller, a printer control method, and a program capable of preventing such trouble as may occur when a dedicated printer is replaced by a different type of printer in a system in which an application program that was developed on the assumption that the dedicated printer would be used is installed.

According to an aspect of the invention, there is provided a printer controller including: a driver module which controls operation of a control subject printer to be controlled; and an application module, wherein the driver module includes: a conversion table referencing section which refers to a conversion table that correlates, for a prescribed printer control item, a control parameter suitable for the control subject printer and a control parameter suitable for a conversion subject printer that is different from the control subject printer; a control parameter acquiring section which acquires the control parameter that is output from the application module, is corresponding to the printer control item, and is suitable for the conversion subject printer; and a control parameter converting section which converts the acquired control parameter into the control parameter suitable for the control subject printer according to the conversion table, and outputs the resulting control parameter.

With the above configuration, the driver module converts a control parameter suitable for the conversion subject printer into a control parameter suitable for the control subject printer and outputs the latter. This makes it possible to prevent trouble as would otherwise be caused in replacing the conversion subject printer with the control subject printer in the case where an application module operates that was developed on the assumption that the conversion subject printer would be used.

### BRIEF DESCRIPTION OF THE DRAWINGS

Embodiments of the present invention will be described in detail based on the following FIGS., wherein:

FIG. 1 is a block diagram showing a general configuration of a printer controller according to an exemplary embodiment of the present invention;

FIG. 2 is a functional block diagram showing functions of the printer controller according to an exemplary embodiment of the invention;

FIGS. 3A and 3B show an exemplary setting file containing a conversion table which is referred to by the printer controller according to an exemplary embodiment of the invention;

FIG. 4 another exemplary setting file containing a conversion table which is referred to by the printer controller according to an exemplary embodiment of the invention; and

FIG. 5 shows an exemplary setting file containing information on the data size of a control information memory area which is referred to by the printer controller according to an exemplary embodiment of the invention.

### DETAILED DESCRIPTION

An embodiment of the present invention will be hereinafter described with reference to the drawings.

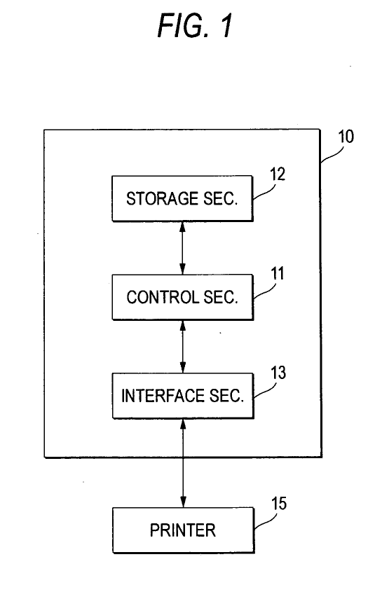

FIG. 1 shows the configuration of an exemplary computer system including a printer controller according to an embodiment of the invention. As shown in FIG. 1, the computer system includes a printer controller 10 and a printer 15.

The printer controller 10, which is a general personal computer, for example, includes a control section 11, a storage section 12, and an interface section 13.

The control section 11 is a CPU, for example, and operates according to programs stored in the storage section 12. In this embodiment, the control section 11 realizes functions of an application module and a driver module (both described later).

The storage section 12, which is a computer-readable storage medium for storing programs to be run by the control section 11, includes memory devices such as a RAM and a ROM and/or a disc device or the like. The storage section 12 also operates as a work memory of the control section 11. Further, the storage section 12 holds various setting files to be referred to by the driver module.

The interface section 13 exchanges data with the printer 15. In particular, the interface section 13 controls operation of the printer 15 by transmitting, to the printer 15, a control instruction coming from the driver module (described later).

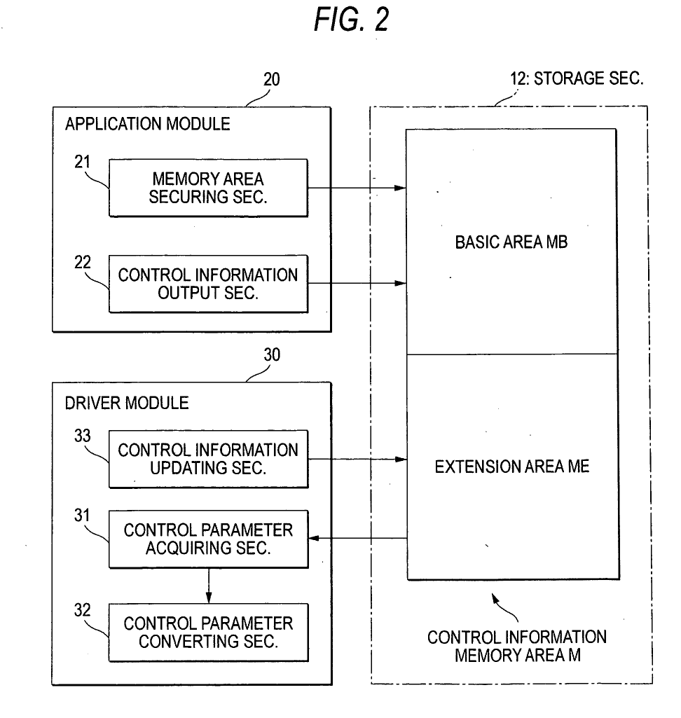

As shown in FIG. 2, the printer controller 10 includes an application module 20 and a driver module 30. The application module 20 includes a memory area securing section 21 and a control information output section 22. The driver module 30 includes a control parameter acquiring section 31, a control parameter converting section 32, and a control information updating section 33. These functions are realized by the control section 11's running a program stored in the storage section 12, for example.

The application module 20 is a module for performing prescribed business work. For example, the business work is performed by the application module 20 includes work using a printer such as printing of a slip. The application module 20 is a dedicated printer (conversion subject printer) that is different from the printer 15, for example.

The memory area securing section 21 secures, in the storage section 12, a control information memory area M for storing printer control information to be used for controlling operation of a printer. For example, the memory area securing section 21 secures a control information memory area M when execution of the application program 20 is started. The secured control information memory area M is subjected to access, for reading or writing of printer control information, by the application module 20 or the driver module 30.

As shown in FIG. 2, the control information memory area M includes a basic area MB and an extension area ME. The basic area MB is a memory area for storing control parameters relating to printer control items that are defined as control items common to all printers in advance. The basic area MB can store control parameters relating to such printer control items as sheet feed tray information.

The extension area ME is a memory area capable of storing control parameters relating to printer control items specific to each printer. Usually, in securing an extension area ME, an application module 20 acquires, from a driver module, information on a data size of a memory area required by the driver module and secures an extension area ME in accordance with the acquired data size. However, since the application module 20 of this embodiment was developed only for the conversion subject printer, the application module 20 secures an extension area ME in accordance with a data size of a memory area required by a driver module for the conversion subject printer irrespective of a printer to be used actually. More specifically, a description will be made below of an example in which the memory area securing section 21 secures a 1,024-byte memory area as an extension area ME.

The control information output section 22 outputs, to the control information memory area M secured by the memory area securing section 21, printer control information that is necessary for controlling operation of a printer. The printer control information that is output from the control information output section 22 includes control parameters, suitable for the conversion subject printer, relating to such printer control items as sheet feed tray information. Specific examples of the printer control information that is output from the control information output section 22 will be described later in detail.

The driver module 30 is a module for controlling operation of the printer 15 on the basis of an instruction from the application module 20. More specifically, the driver module 30 controls operation of the printer 15 using the printer control information that is stored in a control information memory area M secured by the memory area securing section 21.

The control parameter acquiring section 31 acquires, by referring to the control information memory area M, control parameters included in the printer control information that has been output from the application module 20. In acquiring control parameters, the control parameter acquiring section 31 can acquire, by referring to prescribed storage locations, control parameters relating to prescribed printer control items stored in the basic area MB. On the other hand, as described later, the control parameter acquiring section 31 acquires control parameters stored in the extension area ME by acquiring information on storage locations of those control parameters by referring to conversion tables and then referring to those storage locations.

The control parameter converting section 32 outputs the control parameters acquired by the control parameter acquiring section 31 after converting those if necessary. More specifically, the control parameter converting section 32 converts the control parameters that have been output from the application module 20 and are suitable for the conversion subject printer into control parameters suitable for the printer 15 by referring to conversion tables. The resulting control parameters obtained by the control parameter converting section 32 are used for controlling operation of the printer 15.

The control information updating section 33 updates, when necessary, printer control information stored in the control information memory area M. For example, the control information updating section 33 overwrites data in the extension area ME with control parameters relating to items for which the application module 20 has secured no storage locations in the extension area ME among the printer control items that are used for controlling operation of the printer 15. The overwritten printer control information can be a subject of access by the control parameter acquiring section 31 like the information that has been output from the application module 20.

Next, a description will be made of specific examples of the printer control information that is output from the control information output section 22 or the control information updating section 33 as well as specific examples of a process that the driver module 30 acquires output printer control information and converting it.

A description will be made of a first example in which a control parameter relating to a printer control item (sheet feed tray information) stored in the basic area MB is converted. The control information output section 22 writes, as a control parameter, the value of a sheet feed tray ID at a prescribed storage location corresponding to a control item of sheet feed tray information in the basic area MB. The value of a sheet feed tray ID may be defined as a standard specification of a driver module. Even in such a case, since the number of (kinds of) standard specifications is limited, a value specific to a printer may be used. It is assumed here that the control information output section 22 outputs, as the value of a sheet feed tray ID, a value specific to the conversion subject printer. Therefore, if the driver module 30 for the printer 15 controlled operation of the printer 15 using the value of this sheet feed tray ID as it is, the printer 15 would perform an unexpected operation or an error would occur.

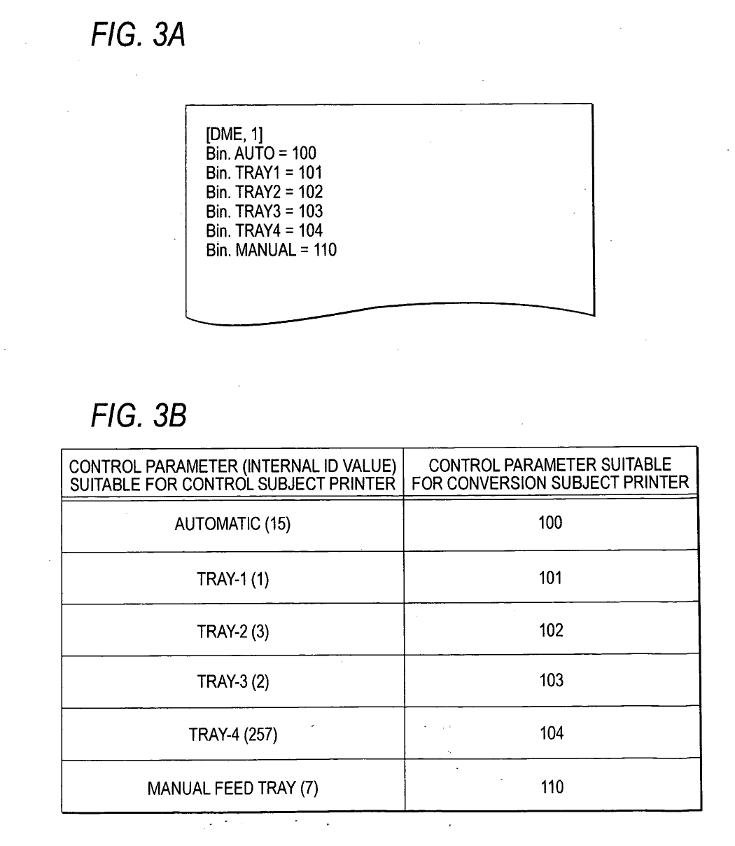

To avoid such an event, the control parameter converting section 32 converts the value of the sheet feed tray ID acquired from the basic area MB by the control parameter acquiring section 31 into a value suitable for the printer 15. More specifically, the control parameter converting section 32 converts the value of the sheet feed tray ID by referring to a conversion table. The conversion table is a table that correlates control parameters suitable for the conversion subject printer with those suitable for the printer 15 for a printer control item as a conversion subject. The conversion table is stored in the storage section 12 as, for example, a setting file of a text file format shown in FIG. 3A. The exemplary setting file of FIG. 3A prescribes a corresponding relationship between control parameters shown in FIG. 3B. For example, if the control information output section 22 outputs “102” as the value of a sheet feed tray ID, the control parameter converting section 32 converts this value into a control parameter representing “sheet feed tray-2” for the printer 15. As a result, when, for example, the application module 20 carries out a print job by designating “102” as a sheet feed tray ID, the driver module 30 can cause the printer 15 to perform printing using the sheet feed tray-2.

Next, a description will be made of a second example in which a control parameter relating to a printer control item (sheet ejection tray information) stored in the extension area ME is. converted. It is assumed here that no storage location for sheet ejection tray information is prepared in the basic area MB. In this case, to perform a control for designating a sheet feed tray as a tray of a printer, the control information output section 22 stores the value of a sheet ejection tray ID in the extension area ME as a control parameter corresponding to a printer control item of sheet ejection tray information. However, since the storage location of this control parameter in the extension area ME depends on the driver module, even if the control parameter acquiring section 31 tries to perform processing similar to the processing in the first example, it cannot acquire the target control parameter from the extension area ME.

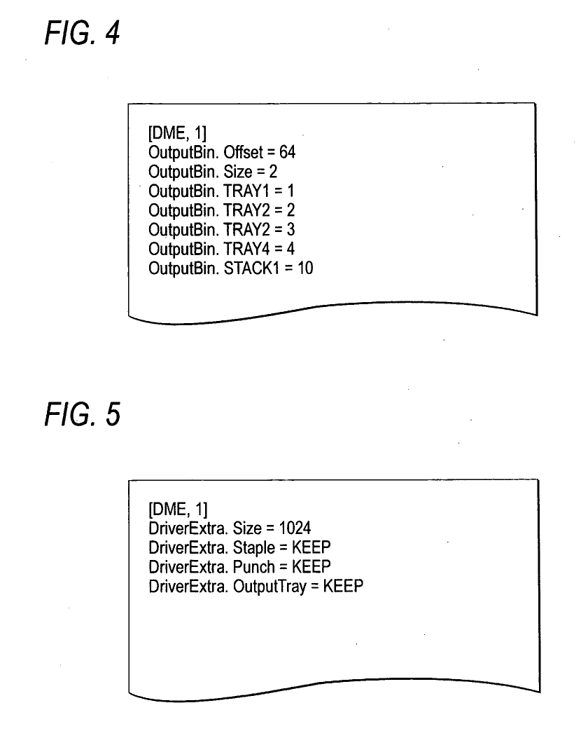

In view of the above, the control parameter acquiring section 31 acquires information on a storage location of the target control parameter by referring to a prescribed conversion table and then acquires the control parameter by referring to that storage location. The conversion table used in this case is held by the storage section 12 as, for example, a setting file shown in FIG. 4. The setting file of the example of FIG. 4 indicates, on the second and third lines, that the target control parameter is stored at a location having an offset value 64 bytes from the head of the extension area ME and its data size is 2 bytes. That is, the value of the sheet ejection tray ID is stored in an area of the 64th to 66th bytes as measured from the head of the extension area ME. The control parameter acquiring section 31 can acquire the value of the sheet ejection tray ID that has been output from the control information output section 22 by referring to the area of the 64th to 66th bytes as measured from the head of the extension area ME.

Then, the control parameter converting section 32 converts the control parameter acquired by the control parameter acquiring section 31 in the same manner as in the first example. More specifically, in the case of the exemplary setting file of FIG. 4, the fourth and following lines show a corresponding relationship between control parameters like the one shown in FIG. 3(a). The control parameter converting section 32 performs a conversion using such a conversion table. In this manner, even in the case where the application module 20 stores, in the extension area ME, by itself, a printer setting item such as sheet ejection tray information whose storage location is not prepared in the basic area MB, the driver module 30 can acquire a control parameter relating to the printer setting item correctly, convert it into a control parameter suitable for the printer 15, and output the latter.

Next, a description will be made of a third example which relates to a printer control item that is not designated by the application module 20. As described above, the memory area securing section 21 secures, in the storage section 12, an extension area ME of 1,024 bytes which is suitable for the conversion subject printer. However, the data size of an extension area to be used by the driver module depends on the corresponding printer. Therefore, if the driver module 30 is supposed to use an extension area of more than 1,024 bytes, the driver module 30 may write or read data to or from a memory area that is located after the 1,024th byte as measured from the head of the extension area ME to cause trouble such as buffer overrun, unless a proper measure is taken.

In view of the above, the control parameter acquiring section 31 and the control information updating section 33, which is to access a control information memory area M, acquires information on the data size of an extension area ME secured by the memory area securing section 21 and restricts access to an excess memory area outside the secured extension area ME on the basis of the acquired information on the data size. More specifically, the driver module 30 acquires information on the data size of an extension area ME secured by the memory area securing section 21 from, for example, a setting file that is held by the storage section 12 in advance. FIG. 5 shows an exemplary setting file containing such data size information in which data size information exists on the second line. The above-described method can prevent trouble that the driver module 30 accesses a memory area outside a control information memory area M even if a difference exists between the data size of an extension area to be used by a driver module for a conversion subject printer and that of an extension area to be used by the driver module 30 for the printer 15.

However, with this method, the driver module 30 cannot acquire control parameters relating to printer control items which should originally be stored in an area that is located after the 1024th byte of the extension area ME. Therefore, the control parameter acquiring section 31 may be configured so as to acquire control parameters of such printer control items from, for example, a setting file that is held by the storage section 12 in advance. More specifically, for example, in the exemplary setting file of FIG. 5, the third and following lines describe such printer control items- and corresponding control parameters. In the example of FIG. 5, a control parameter value “keep” which means that a current setting should be maintained is correlated with each of printer control items of stapler information, punch information, and ejection tray information. The control parameter acquiring section 31 acquire these values, which makes it possible to control operation of the printer 15 using the control parameters described in the setting file even in the case where the application module 20 has not designated control parameters relating to these printer control items.

Alternatively, the control information updating section 33 may overwrite data that is located at a prescribed location before the 1024th byte in the extension area ME with a control parameter relating to a printer control item that should originally be stored in an area that is located after the 1024th byte in the extension area ME. In this case, the control information updating section 33 refers to a setting file that correlates the printer control item, the corresponding control parameter, and a prescribed location in the extension area ME to which to write the control parameter instead of the exemplary setting file of FIG. 5. Then, the control information updating section 33 writes the control parameter information to the prescribed location in the extension area ME obtained by referring to the setting file. The control parameter acquiring section 31 can acquire the control parameter relating to the printer control item by reading out the data stored at the prescribed location in the extension area ME. In this case, employing a location where printer control information that is not used by the driver module 30 is stored as a location to which the control information updating section 33 writes control parameter information makes it possible to store a necessary control parameter in the extension area ME by overwriting printer control information that is set as unnecessary data with the former.

To replace a printer in the above-described computer system according to the embodiment, a user performs the following work. First, the user installs a program of a device driver which corresponds to a control subject printer (replacement printer) and realizes the functions of the above-described driver module 30. Then, the user generates setting files containing conversion tables and information on a data size on the basis of control parameters that are output from the application module 20 according to a conversion subject printer, information on the data size of an extension area ME to be secured, control parameters suitable for the control subject printer (replacement printer), and information on the data size of a necessary extension area ME. Further, the user causes the storage section 12 to hold the generated setting files so that the driver module 30 can refer to those. As a result, the printer controller 10 can control operation of the control subject printer (replacement printer) without any problems without requiring the user to modify the application module 20.

In the above-described embodiment, the driver module 30 converts control parameters suitable for a conversion subject printer into those suitable for a control subject printer and outputs the latter. This makes it possible to control operation of the printer 15 even in the case where the application module 20 operates which uses information of the control parameters suitable for the conversion subject printer, which in turn prevents trouble as would otherwise be caused by replacing the conversion subject printer with the printer 15. Further, since the driver module 30 accesses, on the basis of its data size, an extension area ME secured by the application module 20 for the conversion subject printer, such trouble as buffer overrun can be avoided.

The above description is directed to the example that the driver module 30 converts an output of the application module 20 which is provided for one conversion subject printer into control parameters suitable for the printer 15 and performs other processing. However, there may exist plural conversion subject printers for which the driver module 30 performs a conversion. In this case, the driver module 30 selects one set of setting files from plural sets of setting files that are prepared for the respective conversion subject printers and each contain conversion tables and the data size of an extension area in accordance with an application file that outputs printer control information. The driver module 30 then controls the printer by referring to the selected setting files. In this manner, the driver module 30 can control the printer 15 in a desired manner in accordance with each of plural application modules which were developed on the assumption that different conversion subject printers would be used.

Where a setting file to be referred to is selected from plural setting files, the driver module 30 may acquire information on a printer type such as a printer name or a maker name included in printer control information and select a setting file to be referred to on the basis of the acquired information. With this measure, the driver module 30 can convert control parameters or access a control information memory area in accordance with a conversion subject printer whose use is assumed by an application module that has secured the control information memory area even in the case where the driver module 30 cannot acquire information on a corresponding relationship between application modules and conversion subject printers in advance.

The above description assumes that conversion table to be referred to the driver module 30 and information on the data size of an extension area ME are held by the storage section 12 in the form of setting files of a text file format. This allows a user to specify the value of a control parameter as a conversion subject or information on the data size of a control information memory area by editing a text file. However, the invention is not limited to such a method. For example, a setting information editing section which is equipped with a dedicated user interface may acquire a conversion table or information on data size information that is input by a user and cause the storage section 12 to hold the acquired information.

In the above description, a control information memory area secured by the application module 20 is divided into a basic area and an extension area and the extension area is a memory area whose data size can be varied for each driver module. However, the printer controller according to the invention is applicable to other cases. For example, even where the whole control information memory area is a memory area whose data size is varied for each driver module, operation of a control subject printer can be controlled in accordance with a conversion subject printer that is assumed by the application module 20 by acquiring, by referring to a setting file(s) or the like, information on the data size of the memory area or storage locations of control parameters relating to printer control items stored in the memory area.

According to an aspect of the invention, the conversion table correlates, with the printer control item, address information indicating a position, in printer control information that is output from the application module, of the control parameter corresponding to the printer control item, and the control parameter acquiring section acquires the control parameter included in the printer control information as corresponding to the printer control item on the basis of the address information. With this measure, even if the application module stores a control parameter corresponding to a certain printer control item and being suitable for the conversion subject printer at a location in a memory area that is different than in a standard specification of the driver module, the driver module can correctly acquire the control parameter corresponding to the printer control item.

According to another aspect of the invention, there is provided a printer controller including: a driver module which controls operation of a control subject printer to be controlled; and an application module, wherein the driver module includes: a memory area size acquiring section which acquires a data size of a control information memory area secured by the application module in accordance with a conversion subject printer that is different from the control subject printer; and a memory area accessing section which recognizes the control information memory are a on the basis of the acquired data size, and reads/writes printer control information to be used for controlling operation of the control subject printer by accessing the recognized control information memory area.

With this configuration, the driver module recognizes a control information memory area on the basis of a data size of a control information memory area secured by the application module in accordance with the conversion subject printer and accesses the recognized control information memory area. This makes it possible to read or write printer control information that is output from the application module without causing such a problems as buffer overrun.

The printer controller may be such that the driver module further includes: an additional item table referencing section which refers to an additional item table which correlates a prescribed printer control item with a control parameter that correspond to a printer control item and is suitable for the control subject printer; and a control item overwriting section which overwrites printer control information stored at a prescribed location in the control information memory area with the control parameter corresponding to the printer control item according to the additional item table. With this configuration, even in the case where, for example, the driver module for the control subject printer is supposed to use a memory area that is larger in data size than a control information memory area secured by the application module in accordance with the conversion subject printer, at least part of control information that cannot be stored in the control information memory area for the conversion subject printer can overwrite data in the actually secured control information memory area. This makes it possible to store necessary control information in a memory area and use it even if a difference exists between the data size of a control information memory area for a control subject printer and that of a control information memory area for a conversion subject printer.

According to still another aspect of the invention, there is provided a printer control method for controlling operation of a control subject printer to be controlled in a computer having an application module, the method including the steps of: referring to a conversion table that correlates, for a prescribed printer control item, a control parameter suitable for the control subject printer and a control parameter suitable for a conversion subject printer that is different from the control subject printer; acquiring a control parameter that is output from the application module, corresponds to the printer control item, and is suitable for the conversion subject printer; and converting the acquired control parameter into the control parameter suitable for the control subject printer according to the conversion table, and outputting the resulting control parameter.

According to still another aspect of the invention, there is provided a storage medium storing information for causing a computer having an application module to perform process for controlling operation of a control subject printer to be controlled, the process including: referring to a conversion table that correlates, for a prescribed printer control item, a control parameter suitable for the control subject printer and a control parameter suitable for a conversion subject printer that is different from the control subject printer; acquiring a control parameter that is output from the application module, corresponds to the printer control item, and is suitable for the conversion subject printer; and converting the acquired control parameter into the control parameter suitable for the control subject printer according to the conversion table, and outputting the resulting control parameter.

The entire disclosure of Japanese Patent Application No. 2005-330124 filed on Nov. 15, 2005 including specification, claims, drawings and abstract is incorporated herein by reference in its entirety.

What is claimed is:

1. A printer controller comprising:
a driver module that controls a control subject printer; and
an application module,
wherein the driver module comprises:
a conversion table referencing section that refers to a conversion table that correlates, for a printer control item, a control parameter suitable for the control subject printer and a control parameter suitable for a conversion subject printer that is different from the control subject printer;
a control parameter acquiring section that acquires the control parameter that is output from the application module, is corresponding to the printer control item, and is suitable for the conversion subject printer; and
a control parameter converting section that converts the acquired control parameter into the control parameter suitable for the control subject printer according to the conversion table, and outputs the resulting control parameter.

2. The printer controller according to claim 1, wherein the conversion table correlates, with the printer control item, address information indicating a position, in printer control information that is output from the application module, of the control parameter corresponding to the printer control item, and
the control parameter acquiring section acquires the control parameter included in the printer control information as corresponding to the printer control item on the basis of the address information.

3. A printer controller comprising:
a driver module that controls operation of a control subject printer to be controlled; and
an application module,
wherein the driver module comprises:
a memory area size acquiring section that acquires a data size of a control information memory area secured by the application module in accordance with a conversion subject printer that is different from the control subject printer; and
a memory area accessing section that recognizes the control information memory area on the basis of the acquired data size, and reads/writes printer control information to be used for controlling operation of the control subject printer by accessing the recognized control information memory area.

4. The printer controller according to claim 3, wherein the driver module further comprises:
an additional item table referencing section that refers to an additional item table which correlates a prescribed printer control item with a control parameter that correspond to a printer control item and is suitable for the control subject printer; and
a control item overwriting section that overwrites printer control information stored at a prescribed location in the control information memory area with the control parameter corresponding to the printer control item according to the additional item table.

5. A printer control method for controlling operation of a control subject printer to be controlled in a computer having an application module, the method comprising the steps of:
referring to a conversion table that correlates, for a prescribed printer control item, a control parameter suitable for the control subject printer and a control parameter suitable for a conversion subject printer that is different from the control subject printer;
acquiring a control parameter that is output from the application module, corresponds to the printer control item, and is suitable for the conversion subject printer; and
converting the acquired control parameter into the control parameter suitable for the control subject printer according to the conversion table, and outputting the resulting control parameter.

6. A storage medium storing information for causing a computer having an application module to perform process for controlling operation of a control subject printer to be controlled, the process comprising:
referring to a conversion table that correlates, for a prescribed printer control item, a control parameter suitable for the control subject printer and a control parameter suitable for a conversion subject printer that is different from the control subject printer;
acquiring a control parameter that is output from the application module, corresponds to the printer control item, and is suitable for the conversion subject printer; and
converting the acquired control parameter into the control parameter suitable for the control subject printer according to the conversion table, and outputting the resulting control parameter.
